(19) United States
(12) Patent Application Publication
(10) Pub. No.: US 2010/0270487 A1
(43) Pub. Date: Oct. 28, 2010

(54) ELECTRO-HYDRAULIC POPPET VALVE WITH SUPPLY PRESSURE UNLOADING FUNCTION

(75) Inventor: Steven L. Ambrose, Farmington, MI (US)

Correspondence Address: Quinn Law Group, PLLC, 39555 Orchard Hill Place, Suite 520, Novi, MI, 48375, US

(73) Assignee: Eaton Corporation, Cleveland, OH (US)

(21) Appl. No.: 12/428,004

(22) Filed: Apr. 22, 2009

(51) Int. Cl. F16K 31/02

(52) U.S. Cl. 251/129.15

(57) ABSTRACT

A solenoid-actuated valve assembly includes a valve body defining a supply port in communication with a fluid supply, an upper or first chamber, a lower or second chamber in communication with the first chamber, a first valve seat, and a control port in fluid communication with a downstream hydraulic component. An armature seals against the first valve seat when a solenoid is in a closed position, and a spring otherwise biases the armature against the upper valve seat. A lower valve device is positioned in the second chamber, and has a moveable portion that selectively admits fluid into the second chamber in the open position. The valve body defines at least one orifice between the supply port and the first valve seat, the orifice providing a pressure unloading function for venting fluid that leaks past the valve device when the solenoid is not being actuated.

### TECHNICAL FIELD

The present invention relates generally to electro-hydraulic solenoid valves, and in particular to a solenoid valve having one or more internal poppet-style valve devices.

### BACKGROUND OF THE INVENTION

A solenoid control valve configured for use within an electro-hydraulic fluid control system or fluid circuit can be used to selectively control a flow of oil or other fluid under pressure. Poppet valve assemblies (PVAs) include a cylindrical internal chamber and a tapered or shaped poppet device such as an armature, a ball, or another suitable device. Fluid under pressure is admitted into a valve body portion of the PVA in response to an energizing of a solenoid portion of the PVA. The application of hydraulic and/or magnetic force moves or actuates the poppet device, or multiple poppet or other valve devices, within the internal chamber. Fluid paths therewithin are thus selectively opened to permit fluid flow through various passages of the valve body in order to feed various downstream fluid circuit loads.

Within a PVA, fluid sealing integrity largely depends on the closeness and quality of the mating surfaces of the poppet and valve seat. As a result, some fluid leakage or bypass is ordinarily encountered. Depending on the particular configuration of the poppet device and downstream fluid circuit control system, fluid leakage can vary from somewhat minimal to relatively substantial. The leakage performance of conventional poppet valves and associated control fluid circuitry therefore can be less than optimal. In some hydraulic systems, it would be desirable to unload the supply pressure from a PVA in order to accurately quantify the leakage of the PVA and downstream fluid circuit. In such systems, it is also desirable to minimize the parasitic fluid losses and the cost to implement it. The present invention serves to fulfill these needs.

### SUMMARY OF THE INVENTION

A valve assembly according to one embodiment of the invention has a solenoid portion with an energizable coil and a valve body connected thereto. The valve body contains a valve device having an armature positioned adjacent to the coil and a lower valve that is axially-aligned with the armature. The armature and its valve seat may be collectively referred to as the “upper valve” to denote its downstream position relative to the lower valve. The armature is biased by a resilient member, such as a spring or another suitable return device, and extends axially within a chamber of the valve body toward the lower valve. The lower valve may be configured as a spool valve in one embodiment and a ball poppet in another embodiment, although other suitable valve devices can also be used without departing from the intended scope of the invention.

The solenoid coil can be selectively energized using an energy supply such as a battery, an electrical outlet, or any other available energy supply to move the armature from a first position to a second position, thereby admitting fluid into the valve body via a supply port. Movement of the armature allows the fluid to pass between the lower valve and a lower valve seat and then between the armature and an upper valve seat. The fluid is ultimately discharged from the valve body via a control port where it is delivered to a downstream fluid circuit, e.g., a hydraulic machine and/or process, an automotive system, and/or other hydraulic component or device.

When the valve assembly is closed, which can occur when the coil is in either a de-energized or an energized state as desired, the armature is biased to seal against the upper valve seat. An end of the armature contacting a surface of the lower valve moves the lower valve to at least partially open one or more orifices in the valve body. The orifice vents fluid from the valve assembly, for example to a low-pressure tank or sump external to the valve body, and thus provides a pressure unloading function downstream of the supply port as described herein. Fluid bypass or leakage past the upper valve seat and into the downstream control circuit is thus substantially minimized. Thus, fluid leakage or pressure decay downstream of the valve assembly can be more precisely detected while parasitic losses in the energized state are sufficiently minimized.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a fluid circuit having a valve assembly in accordance with the invention;

FIG. 2 is a schematic cross-sectional illustration of a valve assembly usable within the fluid circuit of FIG. 1 and having a pair of internal valves each in a closed position;

FIG. 3 is a schematic cross-sectional illustration of the valve assembly of FIG. 2 in an open position;

FIG. 4 is a schematic cross-sectional illustration of a valve body portion of an alternate valve assembly in a closed position; and

FIG. 5 is a schematic cross-sectional illustration of the valve body portion of the alternate valve assembly of FIG. 4 in an open position.

### DESCRIPTION OF THE PREFERRED EMBODIMENTS

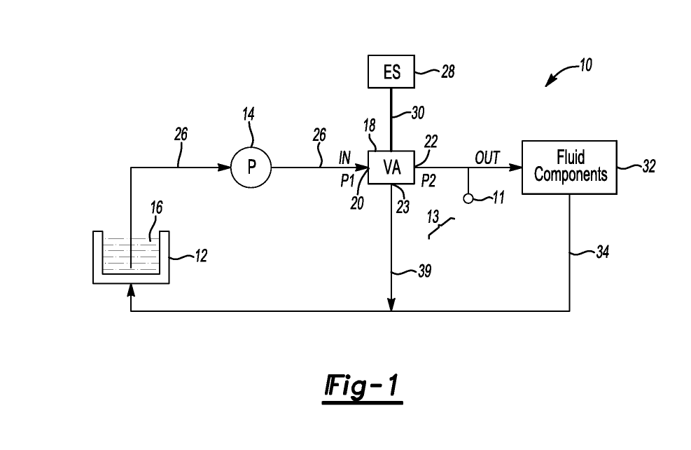

Referring to FIG. 1, a fluid circuit 10 includes a low-pressure tank, reservoir, or fluid sump 12 and a pump (P) 14. The sump 12 contains fluid 16, which is drawn by the pump 14 and delivered under pressure (P1) via a supply line 26 to a solenoid-operated valve assembly (VA) 18. The valve assembly 18 is electrically connected to an energy source 28, also labeled ES in FIG. 1, e.g., a battery, a capacitor, or other suitable electrical or electro-chemical storage device, or an electrical outlet, via a wireless or hard-wired electrical connection 30.

Control logic (not shown) can be implemented to selectively open and close the valve assembly 18 as needed to power a set of fluid components 32, such as but not limited to hydraulic machinery, valves, pistons, accumulators, or other fluid circuit devices. The fluid components 32 in turn are in fluid communication with the sump 12 via a return line 34. A pressure transducer 11 can be positioned downstream of the valve assembly 18 to sense pressure decay in a downstream circuit portion 13 of the fluid circuit 10.

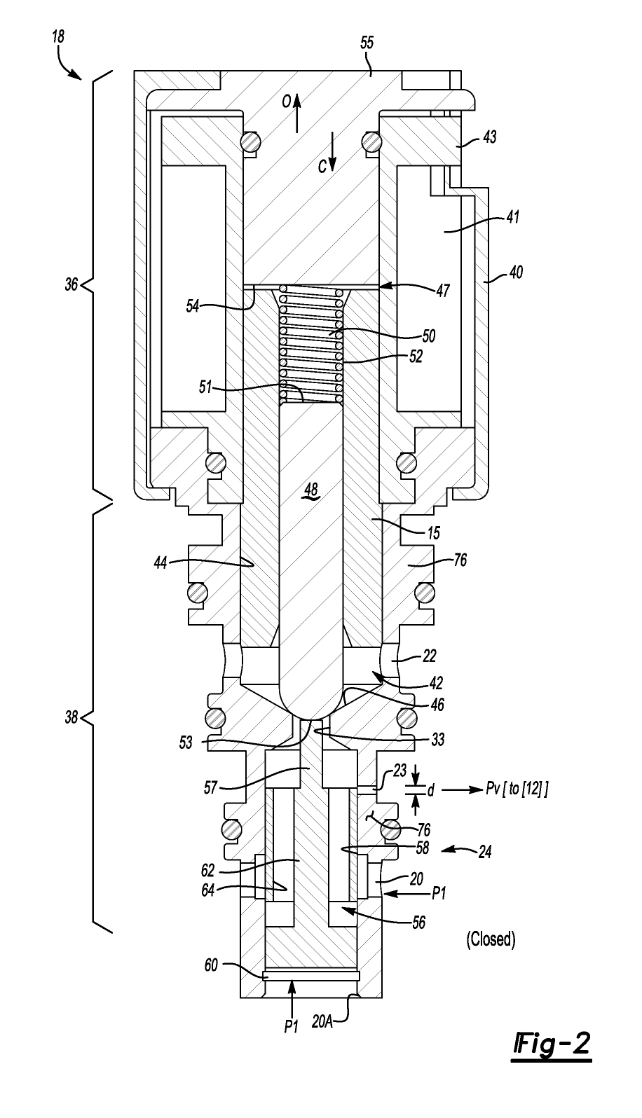

The fluid 16 is admitted into the valve assembly 18 via the supply line 26 at the supply pressure (P1) through a supply port 20. When the valve assembly 18 is turned on, which in a normally-closed device occurs when the valve assembly 18 is selectively energized, the fluid 16 admitted into the valve assembly 18 is ultimately discharged from the valve assembly 18 via a control port 22 at a control pressure (P2). At least one orifice 23 is in fluid communication with the sump 12 via another return line 39 to provide a pressure unloading feature as set forth below with reference to FIGS. 2-5. While a single orifice is shown in the various Figures for simplicity, additional orifices 23 can also be used within the scope of the invention. The number of orifices 23 used may be determined by the amount of available valve stroke, orifice size, and leakage past a lower valve 24 in the open and closed positions as explained below.

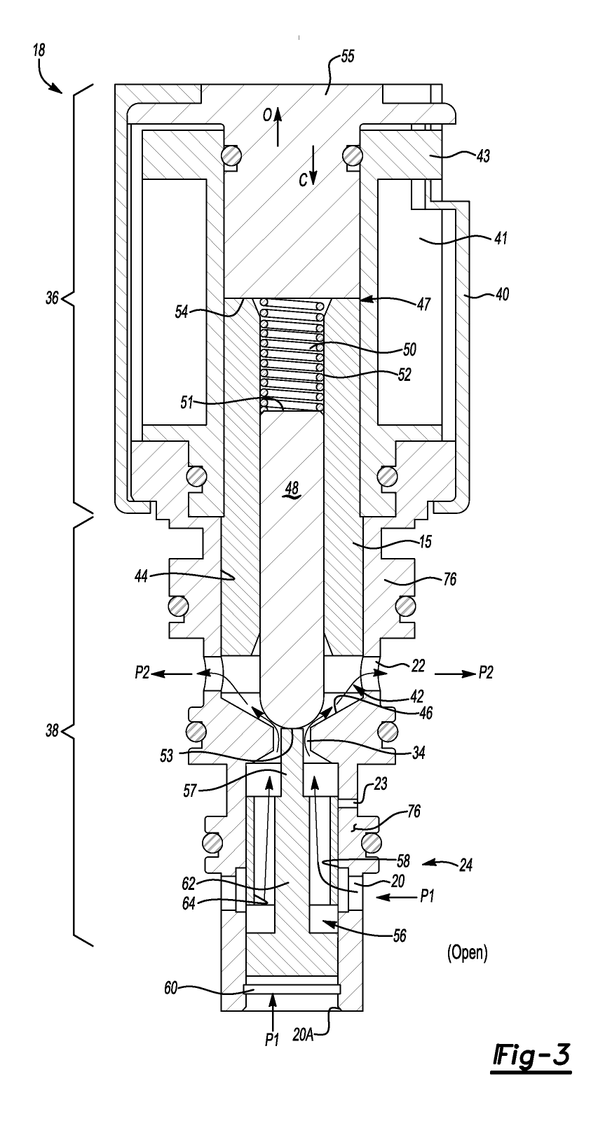

Referring to FIG. 2, the valve assembly 18 is shown in a closed position, blocking passage of a pressure (P1) to the control port 22. The valve assembly 18 includes a solenoid portion 36 and a valve body 38. The solenoid portion 36 is electrically connected to the energy source 28 of FIG. 1, as shown in that Figure. In this embodiment, when the solenoid portion 36 is de-energized in a normally-closed configuration, fluid 16 is blocked from reaching the control port 22. That is, fluid 16 is prevented from being discharged from the valve body 38 via the control port 22, which can be disposed in a wall 76 thereof. In this manner, the control pressure (P2) (see FIG. 3) at the control port 22 is not made available for use by the components 32 shown in FIG. 1.

The valve assembly 18 can be configured as an electro-hydraulic device, and may include a solenoid housing 40 that contains a solenoid winding or coil 41. The coil 41 is wound on a bobbin 43, and can be selectively energized to actuate or power the valve assembly 18. That is, when the coil 41 is de-energized, the valve assembly 18 restricts fluid communication between the supply port 20 and the control port 22. When the coil 41 is energized, a magnetic field is induced, thus generating magnetic flux which ultimately opens the valve assembly 18 to allow flow from the supply port 20 to the control port 22 as shown in FIG. 3 and described below.

In addition to the control port 22, the valve body 38 includes an inner wall 44 defining an upper chamber 42 that defines an upper valve seat 46. An armature 48 moves axially within the upper chamber 42 in the direction of arrow C absent a magnetic field as described above. A resilient member 50 such as a spring or other suitable return device can be positioned between a first end 51 of the armature 48 and an undersurface 54 of a pole portion 55 to react against the undersurface 54, and to thereby provide a sufficient return force for moving the armature 48 in the direction of arrow C when the solenoid portion 36 is de-energized as shown in FIG. 2.

The armature 48 is disposed in a magnetic sleeve 15 to move in conjunction therewith. In one embodiment, the magnetic sleeve 15 may circumscribe the armature 48. The sleeve 15 is moveably disposed within the upper chamber 42 of the valve body 38 and defines an air gap 47 with the undersurface 54 of the pole portion 55. A second end 53 of the armature 48 is configured to seal against the upper valve seat 46 with a predetermined maximum rate of fluid bypass. The armature 48 extends axially toward a lower chamber 56 of the valve body 38 and contacts a lower valve 24 through a connecting port 33, with the connecting port 33 providing fluid communication between the upper and lower chambers 42 and 56, respectively.

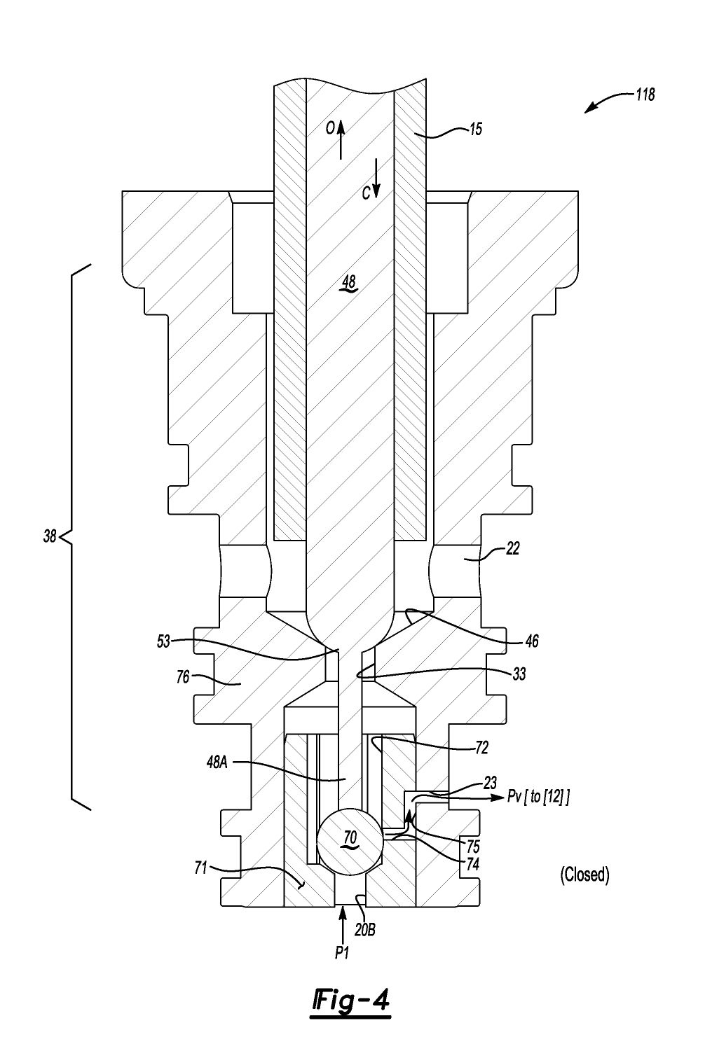

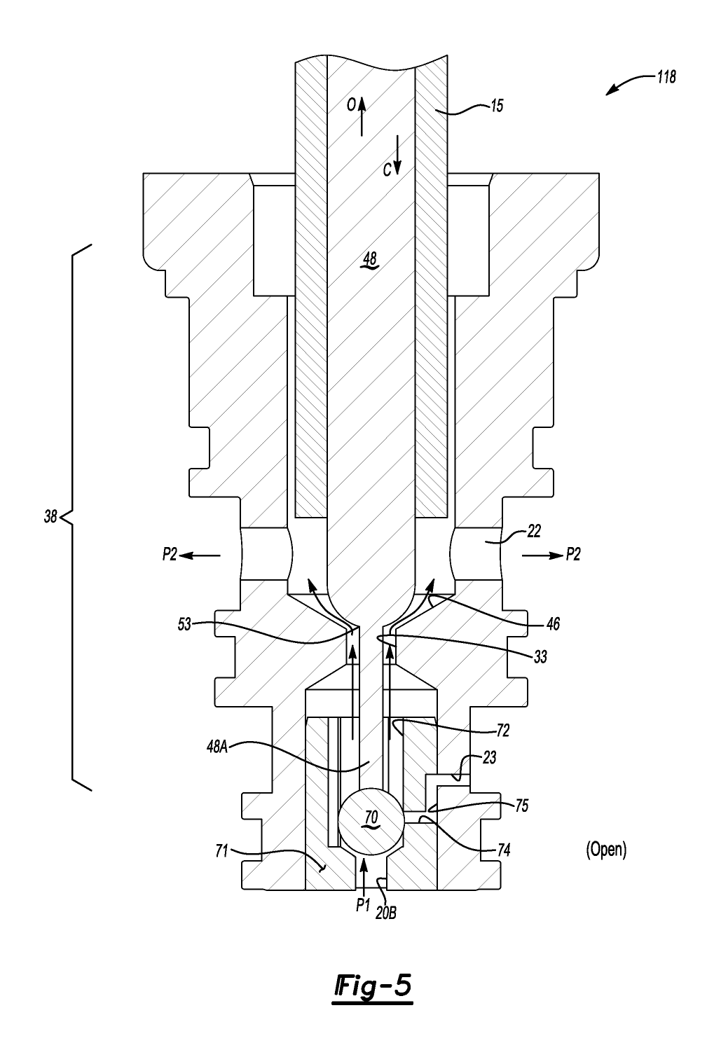

Still referring to FIG. 2, the volume of the lower chamber 56 is defined by an inner wall 58, which contains or houses the lower valve 24. As shown in the embodiment of FIGS. 2 and 3, the lower valve 24 can be configured as a spool valve. However, other embodiments are possible without departing from the intended scope of the invention, including but not limited to the ball poppet of FIGS. 4 and 5 described below.

The valve body 38 also defines the supply force balance port 20A, within which is disposed a stop device 60, e.g., an annular snap ring or other suitable spool-retaining device. When the energy source 28 of FIG. 1 energizes the coil 41, the sleeve 15 is magnetically attracted toward the pole portion 55, and thus the armature 48 moves axially in the direction of arrow O within the upper chamber 42. As a result, the force of the resilient member 50 is overcome and the resilient member 50 compresses against the undersurface 54 (see FIG. 3). As the armature 48 moves in the direction of arrow O, the lower valve 24 is also free to move in the direction of arrow O in response to fluid pressure at the supply force balance port 20A.

When the lower valve 24 is configured as a spool valve as shown in the embodiment of FIGS. 2 and 3, the lower valve can include a spool 62 defining axial fluid passages 64 therein. The spool 62 includes an extension 57 which contacts the armature 48, such that motion of the armature 48 can move the spool 62. When the valve assembly 18 is in an open position as described below, the fluid 16 providing pressure (P1) at the supply port 20, 20A can flow through the axial fluid passages 64, through the connecting port 33, and into the upper chamber 42, where it is ultimately discharged through the control port 22 to provide the control pressure P2. Fluid flow is thus provided with minimal pressure drop across the valve assembly 18, which is preferably less than approximately 0.5 bar(g).

At least one orifice 23 is disposed in the valve body 38 between the lower valve 24 and the armature 48. As noted above, multiple orifices 23 can be used, or just one as shown, depending on a variety of factors. The factors can include, but are not necessarily limited to, available valve stroke, orifice size, allowable leakage past the lower valve 24, etc. For example, one embodiment may include multiple orifices 23 that are approximately equally spaced, e.g., four orifices 23 positioned 90 degrees apart from each adjacent orifice 23. The orifices 23 can be sized as needed for a particular application, e.g., approximately 0.5 mm to approximately 1 mm in diameter according to another embodiment. In some applications, proper venting may not be achievable using a single orifice 23. Also, leakage past the lower valve 24 can be difficult to predict. Therefore, multiple orifices 23 may provided, with some of the orifices 23 plugged as needed to tune the valve assembly 18 for a particular application.

More particularly, the orifice 23 may be formed within the wall 76 of the valve body 38. The rate of fluid flow between the lower chamber 56 and the sump 12 (see FIG. 1) is thus limited by the orifice 23. In the open position shown in FIG. 3, the orifice 23 is restricted by spool 62 and limits a flow of fluid 16, thereby reducing parasitic fluid loss. The orifice 23 also reduces any appreciable pressure build up due to any fluid leakage occurring past the lower valve 24 in the closed position of FIG. 2.

When the valve assembly 18 is in the closed position shown in FIG. 2, the orifice 23 allows for venting of the valve assembly 18 by dumping fluid that leaks past the spool 62. According to one embodiment, the upper valve seat 46 and the armature 48 are manufactured to have less than approximately 100 mg/min of fluid leakage or bypass when in the closed position. Fluid leakage past the lower valve 24 in the closed position can be several orders of magnitude higher and still provide an acceptable pressure unloading function. The orifice 23 is configured with a diameter (d) that provides optimal pressure unloading. In one embodiment, the diameter (d) of the orifice 23 is approximately 0.5 mm to approximately 1 mm. However, other diameter sizes can also be used without departing from the intended scope of the invention.

As noted above, the orifice 23 should be large enough to reduce any appreciable pressure buildup due to fluid leakage past the spool 62 in the closed position. The orifice 23 is also sized small enough to reduce parasitic fluid loss to the sump 12 when the armature 48 and the lower valve 24 are in the open position shown in FIG. 3. The diameter (d) should also be sized to sufficiently minimize any pressure drop across the valve assembly 18 when in the open position shown in FIG. 3.

Referring to FIG. 3, the valve assembly 18 in the illustrated embodiment is open when the solenoid coil 41 is energized, thus allowing the fluid 16 to flow from the port 20 to the control port 22. When a magnetic field is generated, the biasing force of the resilient member 50 is overcome by fluid pressure to causes the armature 48 to move in the direction of arrow O. As the armature 48 moves in the direction of arrow O, the second end 53 thereof moves away from the extension 57. No longer opposed by the armature 48, the lower valve 24 is free to move in the direction of arrow O to allow fluid to flow from the port 20 to the control port 22, and to substantially block the orifice 23, i.e., with at least approximately 75% of the orifice 23 being blocked in one embodiment.

FIGS. 4 and 5 illustrate another valve assembly 118 where the lower valve 24 is configured as a ball poppet. For simplicity, the solenoid portion 36 of FIGS. 2 and 3 is omitted from FIGS. 4 and 5, with the electro-mechanical structure and operation of the solenoid portion 36 described above applying equally to the embodiment of FIGS. 4 and 5. The ball poppet could be used, for example, as a lower-cost device relative to the spool design of FIGS. 2 and 3. However, a ball poppet may be expected to leak at a higher rate relative to the spool design, and therefore a performance vs. efficiency tradeoff may be a consideration in deciding between the particular embodiment to employ in a given fluid circuit.

In the embodiment of FIG. 4, a sphere or ball 70 is biased towards a closed position by the armature 48, for example via an axial arm or armature pin 48A, which can be coupled to the armature 48 described above. A lower valve seat 71 is shaped to form a fluid seal with respect to the ball 70 when the armature pin 48A pushes the ball 70 against or near the lower valve seat 71 as shown in FIG. 4.

The lower valve seat 71 can be made of a suitable material to define a plurality of axial grooves 72 and a radial orifice 74. The ungrooved portions of the lower valve seat 71 contain the ball 70 within an axial path while the grooves 72 allow fluid to be directed past the ball 70. The radial orifice 74 is in fluid communication with the orifice 23 via an annular channel 75 formed in and/or between the lower valve seat 71 and the wall 76 of the valve body 38. In this embodiment, fluid pressure (P1) acting on the ball 70 at control port 20B exceeds or overcomes the return force of the resilient member 50 (see FIGS. 2 and 3). However, some amount of fluid leakage may be present with respect to the ball 70.

Fluid 16 that bypasses the ball 70 is therefore directed through the axial grooves 72, the radial orifice 74, and the annular channel 75, where it is ultimately vented to the sump 12 via the orifice 23 to limit pressure acting on the armature 48. By venting fluid 16 from the valve assembly 18 when the valve assembly 18, 118 is closed, accurate measurement of pressure decay due to fluid leakage is enabled in a downstream fluid circuit, such as the fluid circuit 13 of FIG. 1. The pressure transducer 11 shown in FIG. 1 can be used to perform the required pressure measurements. That is, absent such venting using the orifice 23, measurement accuracy of fluid leakage past the armature 48 and the upper valve seat 46 could be impaired depending upon the severity of the leak.

Referring to FIG. 5, when the valve assembly 118 is energized in a normally-closed configuration, the ball 70 is no longer biased in the direction of arrow C by the armature pin 48A. Fluid pressure (P1) can than move the ball 70 within the axial grooves 72. The ball 70 should move only so far as to substantially block the radial orifice 74, thus minimizing fluid flow into the orifice 23. In this manner, parasitic losses are minimized when the valve assembly 118 is in an energized or open position as shown in FIG. 5.

As will be understood by those of ordinary skill in the art, solenoid-actuated valves such as the valve assemblies 18 and 118 described hereinabove can be configured either as normally open or normally closed devices. A normally-open device would fail, in the event of a power failure, in an open position, closing only when energized. A normally closed device would do precisely the opposite, i.e., failing in a closed position, requiring energizing current to actuate the device. While the valve assembly 18 and 118 are each described hereinabove as being normally-closed devices, either embodiment could be modified as normally open devices without departing from the intended scope of the invention.

While the best modes for carrying out the invention have been described in detail, those familiar with the art to which this invention relates will recognize various alternative designs and embodiments for practicing the invention within the scope of the appended claims.

1. A valve assembly comprising:
a valve body defining a supply port in fluid communication with a fluid supply, a first chamber, a second chamber in fluid communication with the first chamber, a first valve seat, and a control port in fluid communication with at least one hydraulic component;
an armature positioned at least partially in the first chamber, wherein the armature is configured to seal against the first valve seat when the valve assembly is closed, and to move away from the first valve seat to allow fluid to pass to the control port when the valve assembly is open; and
a valve device positioned in the second chamber, and having a moveable portion positioned adjacent to the supply port to selectively admit fluid into the second chamber and past the first valve seat when the valve assembly is open;
wherein the valve body further defines at least one orifice between the supply port and the first valve seat, the orifice providing a pressure unloading function for venting fluid that leaks past the valve device when the valve assembly is closed.

2. The valve assembly of claim 1, further comprising a resilient member positioned between the armature and the solenoid, wherein the resilient member biases the armature against the first valve seat when the valve assembly is closed.

3. The valve assembly of claim 1, wherein the moveable portion is one of a ball and a spool.

4. The valve assembly of claim 3, wherein the moveable portion is the ball, the valve assembly further comprising a second valve seat within the second chamber, wherein the armature includes an axial extension having a free end that selectively moves the ball into contact with the second valve seat when the valve assembly is closed.

5. The valve assembly of claim 4, wherein the first valve seat is a fixed with respect to the valve body, and wherein the second valve seat is moveable with respect to the valve body.

6. The valve assembly of claim 1, wherein the valve device is configured to substantially block the orifice when the valve assembly is open.

7. The valve assembly of claim 5, wherein the orifice blocks at least approximately 75% of a diameter of the orifice when the valve assembly is open.

8. A valve assembly comprising:
a valve body defining a first chamber, a second chamber, a first valve seat at least partially defining the first chamber, a supply port, a control port, and at least one orifice;
a magnetic sleeve disposed within the valve body;
an armature adapted to move in conjunction with the magnetic sleeve and positioned substantially within the first chamber;
a solenoid coil that can be energized to generate a magnetic field sufficient for moving the magnetic sleeve and armature into one of an open and a closed position;
a resilient member that biases the armature against the first valve seat when the valve assembly is closed; and
a valve device positioned within the second chamber and biased by the armature to form a fluid seal with respect to the supply port when the valve assembly is open;
wherein the magnetic sleeve and the armature move away from the first valve seat in the open position when the valve assembly is open to allow the valve device to move away from the supply port, thus admitting fluid into the valve body and to the control port; and
wherein the magnetic sleeve and the armature move toward the first valve seat in the closed position to block fluid inlet into the valve body and allow a predetermined amount of fluid leakage past the valve device to be vented through the orifice and out of the valve body.

9. The valve assembly of claim 8, wherein the valve device includes one of a spool and a ball.

10. The valve assembly of claim 8, wherein the armature is circumscribed by the magnetic sleeve.

11. The valve assembly of claim 8, wherein the first valve seat defines a connecting port between the first chamber and the second chamber, and wherein the armature extends axially through the connecting port.

12. A valve assembly comprising:
a valve body defining a supply port and at least one orifice for selectively venting fluid out of the valve body when the valve assembly is closed;
a valve device positioned within a first chamber of the valve body; and
a moveable armature positioned at least partially within a second chamber of the valve body that is downstream of the first chamber, the moveable armature being adapted for biasing the valve device in a first direction to minimize fluid inlet through the supply port when the valve assembly is closed;
wherein one end of the orifice is disposed within the first chamber.

13. The valve assembly of claim 12, wherein the valve device is one of a spool valve and a ball poppet.

14. The valve assembly of claim 13, including the spool valve, wherein the spool valve is configured to substantially block the orifice when the valve assembly is open.

15. The valve assembly of claim 13, including the ball poppet and a valve seat, wherein the valve seat defines a plurality of axial grooves for retaining a ball portion of the ball poppet in an axial path when the valve assembly is open.

16. The valve assembly of claim 15, wherein the valve seat defines a radial channel forming a fluid path between the axial grooves and the orifice when the valve assembly is closed.
